(19) United States
(12) Patent Application Publication
(10) Pub. No.: US 2024/0128498 A1
(43) Pub. Date: Apr. 18, 2024

(54) MULTILAYER ELECTROLYTE, SOLID-STATE BATTERY INCLUDING THE SAME, AND METHOD(S) OF MAKING THE SAME

(71) Applicants: Arvind KAMATH, Los Altos, CA (US); Shahid PIRZADA, San Jose, CA (US); Zhongchun WANG, San Jose, CA (US); Hui YANG, San Jose, CA (US)

(72) Inventors: Arvind KAMATH, Los Altos, CA (US); Shahid PIRZADA, San Jose, CA (US); Zhongchun WANG, San Jose, CA (US); Hui YANG, San Jose, CA (US)

(73) Assignee: Ensurge Micropower ASA, Oslo (NO)

(21) Appl. No.: 18/314,616

(22) Filed: May 9, 2023

Related U.S. Application Data
(60) Provisional application No. 63/343,035, filed on May 17, 2022.

(51) Int. Cl. H01M 10/0562; H01M 4/485; H01M 4/58; H01M 4/66; H01M 10/02

(52) U.S. Cl. CPC H01M 10/0562; H01M 4/485; H01M 4/5825; H01M 4/661; H01M 4/664; H01M 10/02; H01M 2004/028

(57) ABSTRACT

A solid-state battery cell, a solid-state battery, and methods of making the same are disclosed. The solid-state battery cell includes a cathode current collector, a cathode on the cathode current collector, a low-impedance interface film on the cathode, a solid-state electrolyte on or over the low-impedance interface film, a lithiophilic layer on or over the solid-state electrolyte, and an anode current collector on or over the lithiophilic layer. The low-impedance interface film may include an oxide, a nitride or an oxynitride of lithium and a metal selected from aluminum, silicon and titanium, carbon, a metal oxide, fluoride, oxyfluoride or phosphate, or an alkali metal borate, and may have a thickness of 5-100 Å, for example. The lithiophilic layer may be or include a metal oxide, silicate, aluminate or fluoride, or an elemental metal or metalloid, and may have a thickness of 5 Å to 1 μm, for example.

### REFERENCE TO RELATED APPLICATIONS

This application claims the benefit of U.S. Provisional Pat. Appl. No. 63/343,035, filed May 17, 2022, pending, incorporated herein by reference in its entirety.

### FIELD OF THE INVENTION

The present invention generally relates to the field of solid-state and/or thin film batteries. More specifically, embodiments of the present invention pertain to a multilayer electrolyte, a high energy-density, fast-charging solid-state battery including the same, and methods of making the multilayer electrolyte and the battery.

### DISCUSSION OF THE BACKGROUND

Most thin film solid state batteries use an electrolyte of RF sputtered lithium phosphorus oxynitride (LIPON), typically 1-2 μm thick. This sputtering process is relatively slow, and can experience multiple adverse issues in manufacturing through RF interactions, composition variability, etc. The LIPON electrolyte is deposited on a cathode surface, which must be maintained in a precleaned state, with immediate processing between the cathode and electrolyte deposition process. This is onerous to manufacturing at or on a large scale.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to solid-state and thin film batteries, and more specifically to a solid-state battery and method(s) of making the same. In one aspect, the present invention relates to a method of making a solid-state battery cell, comprising forming a cathode on a substrate, forming a low-impedance interface film on the cathode, forming a solid-state electrolyte on or over the low-impedance interface film, forming a lithiophilic layer on or over the solid-state electrolyte, and forming an anode current collector on or over the lithiophilic layer. The method may further comprise encapsulating the substrate, the cathode, the low-impedance interface film, the solid-state electrolyte, the lithiophilic layer and the anode current collector, forming an opening in the encapsulation exposing the anode current collector, and forming a conductive redistribution layer on the exposed anode current collector and the encapsulation, the redistribution layer also being on a first sidewall of the solid-state battery cell.

In some embodiments, the low-impedance interface film may be formed by depositing or growing an oxide, a nitride or an oxynitride of lithium and a metal selected from aluminum, silicon and titanium by atomic layer deposition (ALD). In further embodiments, the solid-state electrolyte may be formed by depositing or growing the solid-state electrolyte by atomic layer deposition using the same process (ALD) tool as for depositing or growing the oxide, nitride or oxynitride of lithium and the metal, without exposing the lithium metal oxide, nitride or oxynitride layer and the electrolyte layer to air (e.g., without breaking vacuum or opening the tool to an external atmosphere or environment). In even further embodiments, the lithiophilic layer may be formed by depositing the lithiophilic layer by atomic layer deposition using the same (ALD) process tool as for the electrolyte layer and, optionally, for the low-impedance interface film.

In various embodiments, the low-impedance interface film may comprise an oxide, a nitride or an oxynitride of lithium and a metal selected from aluminum, silicon and titanium, the solid-state electrolyte layer comprises lithium phosphorus oxynitride (LiPON), the lithiophilic layer may comprise an oxide of one or more metals including Ti and/or Ni, the cathode may comprise a lithium metal oxide or a lithium metal phosphate, and the anode current collector may comprise nickel, tungsten, copper, titanium or an alloy or conductive nitride thereof. In other or further embodiments, the substrate may comprise a metal sheet, roll or foil, which may also function as a cathode current collector. The metal foil substrate may be in the form of a sheet or roll, and the present method may comprise making a plurality of the battery cells as (i) an array of rows and columns on the sheet, or (ii) a plurality of rows or columns on the roll, and each step in the method may be performed using roll-to-roll (R2R) processing.

In some embodiments, the anode current collector may be formed by blanket-depositing the anode current collector by physical vapor deposition (e.g., sputtering, evaporation, etc.), although the anode current collector may be formed by other processes as well (e.g., ALD, printing, etc.). When the anode current collector is formed by blanket deposition, forming the anode current collector may further comprise patterning the anode current collector (e.g., by laser ablation, low-resolution photolithographic patterning and development of a photoresist and etching, etc.).

The method of making the solid-state battery generally comprises the method of making the battery cell, optionally stacking a plurality of the battery cells (e.g., so that the redistribution layer is along the first sidewall of each solid-state battery cell and the cathode current collector of each cell is exposed along a second, opposite sidewall of the solid-state battery cell[s]), placing an adhesive on the battery cell(s) (e.g., above or below each cell, or between adjacent cells in a stack of such cells), and depositing a conductor on each of the opposite sidewalls (i.e., the first sidewall and the second, opposite sidewall of the battery cell) to form first and second terminals of the solid-state battery.

The present invention also relates to a solid-state battery cell, comprising a cathode current collector (CCC), a cathode on the cathode current collector, a multi-layer solid-state electrolyte on the cathode, and an anode current collector (ACC) on the multi-layer electrolyte. The multi-layer solid-state electrolyte comprises a low-impedance interface film on the cathode, a bulk electrolyte on the low-impedance interface film, and a lithiophilic layer on the bulk electrolyte.

In various embodiments, the low-impedance interface film may comprise (i) an oxide, a nitride or an oxynitride of lithium and a metal selected from aluminum, silicon and titanium, (ii) carbon, (iii) an oxide of a Group 14, 15 or 16 metal, such as zirconium or tungsten, (iv) a fluoride, oxyfluoride or phosphate of a Group 13, 14 or 15 metal, such as aluminum or bismuth, or (v) an alkali metal borate. For example, the oxide, nitride or oxynitride of lithium and the metal may comprise LiAlO₂, Li₂TiO₃, a lithium silicon oxynitride or lithium titanium nitride. In some cases, the low-impedance interface may have a thickness of 5-100 Å, but the invention is not limited to such values.

In other or further embodiments, the cathode may comprise a lithium metal oxide or a lithium metal phosphate. For example, the cathode may comprise lithium cobalt oxide, lithium manganese oxide, or lithium iron phosphate.

In most embodiments, the solid-state electrolyte layer comprises lithium phosphorus oxynitride (LiPON). However, the invention is not limited to battery cells in which the solid-state electrolyte layer is LiPON. The electrolyte layer may have a thickness of from 100 Å to 2 microns, but the invention is not limited to this range of thicknesses.

In various embodiments, the lithiophilic layer may comprise a metal oxide, a metal silicate, a metal aluminate, a metal aluminosilicate, a metal fluoride, or an elemental main group metal or semi-metal/metalloid. For example, the metal oxide, silicate or aluminate may comprise an oxide of one or more metals including Ti, Ni, Zn, Sn, Si and/or Al, such as titanium dioxide, nickel oxide, zinc oxide, tin oxide, silica, or alumina. In addition, the lithiophilic layer may have a thickness of 5 Å to 1 μm, but the invention is not limited to this range.

In other or further embodiments, the anode current collector may comprise nickel, tungsten, copper, titanium or an alloy or conductive nitride thereof. For example, the anode current collector may be or comprise titanium nitride or titanium aluminum nitride. In some cases, the anode current collector has a thickness of 1000-10,000 Å, but the invention is not limited to this range.

In some embodiments, the cathode current collector comprises a metal sheet, roll or foil. The metal foil may be in the form of a sheet or roll, and may also function as a mechanical substrate supporting the remainder of the battery cell and/or on which the battery cell may be formed. The metal foil may comprise stainless steel, aluminum, copper, nickel, inconel, brass, molybdenum or titanium, and the aluminum, copper, nickel, molybdenum or titanium foil may be alloyed with up to 10% of one or more other elements. The cathode current collector may further comprise first and second barriers (e.g., barrier layers) on opposite surfaces of the metal sheet, roll or foil. Each of the first and second barriers may comprise one or more layers of one or more metal nitrides in a thickness effective to prevent migration of atoms or ions from the metal foil. For example, the first and second barriers may be or comprise a refractory or non-refractory metal nitride, such as aluminum nitride, titanium nitride, titanium aluminum nitride, tungsten nitride, etc. Alternatively, the first and second barriers may comprise a glass or ceramic, such as silicon dioxide, aluminum oxide, silicon nitride, a silicon and/or aluminum oxynitride, etc., or an amorphous metal alloy, such a TiW alloy.

The present battery may comprise one or more of the present battery cells, and further comprise a barrier and/or insulation film encapsulating the substrate, the cathode, the multi-layer solid-state electrolyte and the anode current collector, an opening in the barrier and/or insulation film exposing the anode current collector, and a conductive redistribution layer on the exposed anode current collector, the barrier and/or insulation film, and a first sidewall of the solid-state battery/cell. The battery may even further comprise first and second terminals, one electrically connected to the ACC, and the other electrically connected to the cathode or the CCC.

The capabilities and advantages of the present invention will become readily apparent from the detailed description of various embodiments below.

### BRIEF DESCRIPTION OF THE DRAWINGS

FIGS. 1A-C are cross-sectional views of various cathode structures in a solid-state battery.

FIG. 2 is a cross-sectional view of an exemplary multi-layer solid-state electrolyte, according to embodiments of the present invention.

FIGS. 3-8 are cross-sectional views of structures in an exemplary method of making a solid-state battery, according to embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present solid-state battery may be an intrinsic anode-less battery, including a substrate, a cathode on the substrate, the multi-layer solid-state electrolyte (SSE) on the cathode, and an anode current collector (ACC) on the SSE. The substrate, which may comprise a metal foil, can serve as the cathode current collector (CCC). Due to its anode-less nature, a conventional lithium anode may not be present between the SSE and ACC.

The following discussion provides examples of multi-layer solid-state electrolytes, solid-state and/or thin film batteries including the same, and general manufacturing processes for such electrolytes and batteries.

The present multi-layer solid-state electrolyte, solid-state battery, and method(s) reduce impedance at one or more interfaces with the electrolyte, and make such interface impedance insensitive to external and/or incoming surface contamination, thereby controlling some variable physical and electrical properties of the battery, and leading to faster charging and discharging cycles. The multi-layer electrolyte can be made in a single tool or apparatus, facilitating integration of the multi-layer electrolyte in the battery manufacturing process. The present multi-layer solid-state electrolyte, solid-state battery, and method(s) may enable thinner batteries and higher volumetric energy densities. The present multi-layer solid-state electrolyte, solid-state battery, and method(s) can include one or more moisture barriers/layers that may also function as a lithiophilic layer (which can also increase the number of charging and discharging cycles and the battery lifetime). The present battery and method(s) can be anode-less, although inclusion of an anode is possible, albeit with a lower output voltage. Optionally, the present solid-state battery and method(s) can integrate manufacture of the uppermost metal (i.e., the anode current collector) into the same tool as the multi-layer solid-state electrolyte, for complete self-sealing of the active layers of the battery.

### An Exemplary Method of Making a Multi-Layer Solid-State Electrolyte

Use of integrated single- or multi-purpose layers before and/or after formation of a bulk solid-state electrolyte, preferably grown by atomic layer deposition (ALD), enables manufacturing a relatively high-performance anode-less (e.g., lithium-free) solid-state battery in a non-dry room manufacturing environment. Use of an ultrathin lithiophilic layer enables consistent lithium nucleation at the anode interface (e.g., at the interface between the electrolyte and the ACC) during charging and discharging, and maintains a reservoir of lithium at the anode interface. In this invention, a multilayer electrolyte is formed. Each layer in the electrolyte serves a purpose.

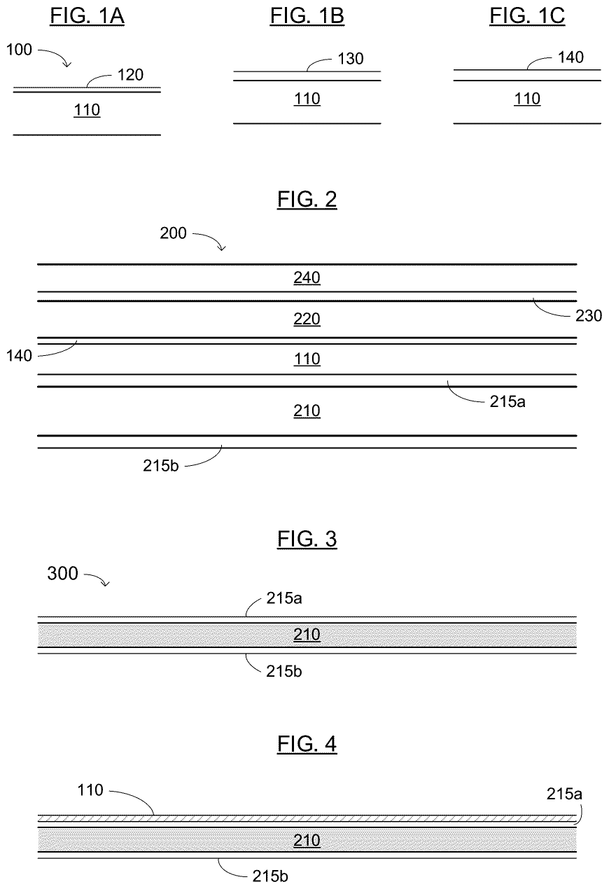

Typical cathodes in solid-state batteries comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. In various embodiments, a pretreatment step can clean up contamination (for example, Li₂CO₃) that may be on or near the surface of the cathode. FIGS. 1A-C show structures relevant to such cathode pretreatment.

FIG. 1A shows a typical case, in which a high-impedance surface contamination layer 120 (e.g., Li₂CO₃) is on a typical lithium cobalt oxide (LCO) cathode 110. FIG. 1B shows a metal oxide or nitride layer 130 thereon. The metal oxide or nitride may comprise alumina (Al₂O₃), titania (TiO₂), or titanium nitride (Ti₃N₄). The metal oxide or nitride layer 130 consumes the Li₂CO₃ (e.g., by converting it to lithium oxide or a lithium metal oxide or oxynitride), but it still has a relatively high impedance.

FIG. 1C shows a low impedance interface layer 140 on a cathode 110, where the low impedance interface layer 140 includes a metal that is different from the metal(s) in the cathode. In some embodiments, the low impedance interface layer 140 comprises a lithium metal oxide, nitride or oxynitride. For example, the metal in the lithium metal oxide, nitride or oxynitride may be aluminum (e.g., a lithium aluminate), silicon (e.g., a lithium silicate), or titanium (e.g., a lithium titanate), and the lithium metal oxide, nitride or oxynitride may be LiAlO₂, Li₂TiO₃, lithium silicon oxynitride or lithium titanium nitride. Alternatively, the low impedance interface layer 140 may comprise carbon (e.g., graphene, conductive graphite), a Group 14, 15 or 16 metal oxide (e.g., ZnO, WO₃, and lithiated forms thereof), a Group 13, 14 or 15 metal fluoride or oxyfluoride (e.g., AlF₃, BiOF) or phosphate (e.g., AlPO₄), or an alkali metal borate (e.g., Li₂B₂O₇), which may contain one or more further metals. Through the use of a combination treatment, including a lithium ALD precursor (e.g., lithium hexamethyldisilazane [LiHMDS], lithium t-butoxide), a metal ALD precursor (e.g., of aluminum, titanium, zirconium, tungsten, or bismuth, such as trimethylaluminum, tetrakis[dimethylamido]titanium [TDMAT], TiCl₄, Zr(NMe₂)₄ Zr[OC(CH₃)₃]₄, ZrI₄, ZrCl₄, bis(t-butylimido)-bis(dimethylamido)tungsten, WF₆, Bi(OCMe₃)₃, Bi(N(SiMe₃)₂)₃, etc.), an oxidizer or oxygen source (e.g., H₂O, O₂, ozone), an optional nitrogen source (e.g., NH₃), and/or a precursor or source carbon in ALD (e.g., benzene, naphthalene, etc.), the surface contamination layer can be reacted and removed or converted to a lower-impedance material, thereby forming a low-impedance interface 140 between the cathode 110 (for example, LCO) and the electrolyte (to be described later). This low-impedance lithium metal oxide, nitride or oxynitride film 140 can be 5-100 Å thick, or any thickness or range of thicknesses therein (e.g., 5-50 Å), although the invention is not limited to this range.

The next step may also be integrated in an atomic layer deposition process tool. For example, and now referring to FIG. 2, a solid-state electrolyte layer 220 such as LIPON is deposited using a lithium source (e.g., LiHMDS, Li t-butoxide) coupled with a phosphorus and/or nitrogen source (e.g., diethyl phosphoramide [DEPA], trimethyl phosphine [TMP], NH₃, etc.). When the lithium metal oxide, nitride or oxynitride layer 140 and the electrolyte layer 220 are deposited sequentially in an ALD tool, no exposure to air is made, preserving the interface between the layers 140 and 220 under vacuum. The electrolyte layer/film 220 is typically from 100 Å to 2 microns thick.

This is then followed in situ by depositing a lithiophilic layer 230 such as a metal oxide (e.g., TiO₂, NiO, ZnO, SnO₂, SiO₂, Al₂O₃, or a combination thereof, such as a metal silicate, aluminate, or aluminosilicate) that can also be deposited by ALD. Alternatively, the lithiophilic layer 230 may comprise a metal fluoride (e.g., SnF₂, ZnF₂, AlF₃) or an elemental main group metal or semi-metal/metalloid (e.g., noble metals such as Ag, metalloids such as Si and Sn, main group metals such as Zn and Al, etc.). The lithiophilic layer 230 may have a thickness of 5 Å to 1 μm, although the invention is not so limited. Thicker films can serve as an anode or anode support, completely absorbing all of the lithium from the cathode (e.g., when the battery output voltage is 2.5V), whereas an ultrathin lithiophilic layer 230 having a thickness of, e.g., 50 Å serves to uniformly nucleate lithium (e.g., to form an anode during charging) and maintain a lithium reservoir during the discharge process that eases the nucleation during further charge cycles. The lithiophilic layer 230 can also serve as a moisture barrier in the event that the substrate 210 is transferred to another chamber for deposition of the top metal (anode current collector) 240 by a relatively high-throughput method, such as PVD (Physical Vapor Deposition). The lithiophilic layer 230 preferably also acts as a moisture barrier protecting the electrolyte layer 220 from trace moisture and CO₂ in the ambient, which can cause the electrolyte layer 220 to form low-conductivity Li₂CO₃ and LiOH. When the lithiophilic layer 230 comprises TiO₂ (for example), it may also function as a moisture barrier protecting the moisture-sensitive electrolyte layer 220 from ambient moisture ingress, allowing for removal and/or processing in a non-dry room manufacturing environment.

A top metal film (i.e., the anode current collector) 240 is formed on the lithiophilic layer 230, typically by blanket deposition and patterning (see, e.g., the discussion of FIG. 6 below). In one option, the blanket layer for the anode current collector 240 is formed by ALD in the same ALD apparatus as the other layers. The anode current collector 240 is lithium-compatible, and may comprise or consist of for example nickel, tungsten, copper, titanium or an alloy or conductive nitride thereof (e.g., titanium nitride or titanium aluminum nitride). The typical thickness of the anode current collector 240 is >1000 Å (e.g., 1000-10,000 Å). ALD tends to be a slow process relative to PVD, and for this reason, PVD may be a preferred technique for blanket deposition of the layer of material for the anode current collector 240 during manufacturing.

In one embodiment, the cathode 110, the low-impedance interface film 140, the solid-state electrolyte 220, the lithiophilic layer 230, and (optionally) the anode current collector 240 are all deposited by ALD in a single process sequence (i.e., without opening the deposition chamber or breaking the vacuum seal). The top metal ACC 240 may be formed by ALD or PVD. Both the ALD and the PVD may be performed at a temperature in the range of 100-350° C. The deposition steps in the ALD apparatus are sequential, thereby eliminating exposure to ambient environments.

### An Exemplary Method of Making a Solid-State Battery

FIGS. 3-8 show intermediate and final structures in an exemplary method of making a solid-state battery. FIG. 3 shows a substrate 300, comprising a metal foil, sheet or film 210 and optional first and second barriers 215a-b on opposite major surfaces of the metal foil, sheet or film 210. When the foil, sheet or film 210 is a metal foil, the first and second barriers 215a-b are not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the sheet or film can also be a metal sheet or metal roll. For example, the sheet or film may be 10-100 μm thick, whereas a metal sheet may have a thickness of >100 μm, up to about 1-2 mm, although the invention is not so limited. Other alternative substrates include a metal coating on a mechanical substrate, such as aluminum, copper, nickel, titanium, etc., on a removable plastic film, sheet or roll.

The barrier 215a-b comprises one or more layers of one or more materials in a thickness effective to prevent migration of atoms or ions from the metal foil, sheet or film 210 into overlying layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, etc. In some embodiments, each of the first and second barriers 215a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 215a or 215b may have a total thickness of 0.5-3 μm, but the barrier 215 is not limited to this range. The barriers 215a-b may be blanket-deposited onto the foil, sheet or film 210 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. No. 9,299,845 and U.S. patent application Ser. No. 16/659,871, filed Oct. 22, 2019 (Atty. Docket No. IDR5090), the relevant portions of each of which are incorporated by reference herein.

In some embodiments, the foil, sheet or film 210 functions as a cathode current collector. In such embodiments, at least the barrier 215a (and optionally the barrier 215b) is a conductive, amorphous material, such as the metal nitrides listed herein or an amorphous metal alloy (e.g., a TiW alloy).

FIG. 4 shows the metal substrate 300 with a cathode 110 thereon. The cathode 110 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 110 may be blanket deposited by laser deposition (e.g., pulsed laser deposition or PLD), sputtering, chemical vapor deposition (CVD), ALD, sol-gel processing, etc. Alternatively, the cathode 110 may be selectively deposited by screen printing, inkjet printing, spray coating, or extrusion coating (e.g., using an ink comprising one or more sol-gel precursors and one or more solvents, having a viscosity appropriate for the printing or coating technique).

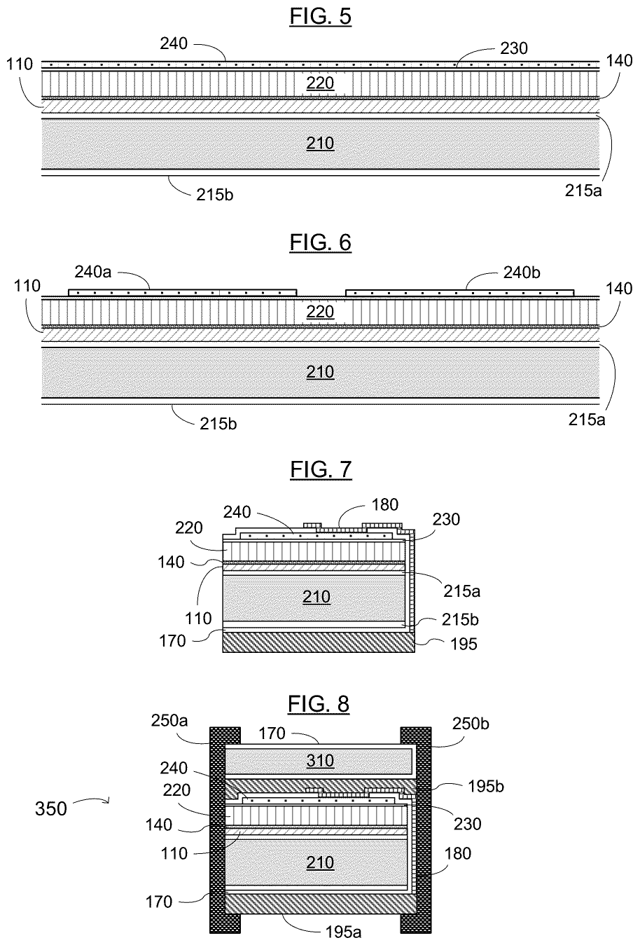

FIG. 5 shows the low-impedance interface film 140 on the cathode 110, the solid-state electrolyte 220 on the low-impedance interface film 140, the lithiophilic layer 230 on the solid-state electrolyte 220, and the ACC layer 240 on the lithiophilic layer 230. The low-impedance interface film 140, the solid-state electrolyte 220, the lithiophilic layer 230 and the ACC 240 are as described above. For example, the electrolyte 220 may comprise or consist essentially of a conventional lithium phosphorus oxynitride (LiPON), which may optionally be carbon-doped, or Li₂WO₄, a good Li-ion conductor.

As an alternative to ALD, the electrolyte 220 may be formed by depositing a LiPON layer or a tungsten oxide layer of the formula WO₃, (0≤x≤1) by sputtering, optionally using pulsed DC power. The sputtering target may comprise a Li₃PO₄ or mixed graphite-Li₃PO₄ target, the latter of which may contain 1-15 wt % of graphite, when the electrolyte 220 comprises LiPON or carbon-doped LiPON, and a metallic/elemental tungsten target when the electrolyte 220 comprises a tungsten oxide. In the latter case, sputtering is performed in an oxygen or oxygen-containing atmosphere. The method of making the electrolyte 220 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500° C. for a length of time of 5-240 minutes, or any temperature or length of time therein (e.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

FIG. 6 shows a number of anode current collectors (ACCs) 240a-b on the lithiophilic layer 230, thus forming substantially complete (but unsealed) cells. A separately-formed anode is not necessary in the present solid-state lithium batteries, as a lithium anode can be formed between the lithiophilic layer 230 and the anode current collectors 240a-b during charging, if necessary. Optionally, however, a thin lithium anode can be deposited by evaporation onto the lithiophilic layer 230 prior to formation of the anode current collector layer 240.

The anode current collectors 240a-b generally comprise a conductive metal, such as nickel, zinc, copper, alloys thereof (e.g., NiV), etc., or another conductor, such as graphite. As an alternative to blanket deposition and patterning (e.g., low-resolution photolithography, development and etching), the anode current collectors 240a-b can be selectively deposited by screen printing, inkjet printing, spray coating, etc. The anode current collectors 240a-b may have a thickness of 0.1-5 μm, although it is not limited to this range.

The anode current collectors 240a-b may have area dimensions (i.e., length and width dimensions) that are 50-90% of the corresponding length and width dimensions, respectively, of the cell (see e.g., FIG. 7), although the borders of the anode current collectors 240a-b may be offset (pulled back) a minimal distance from the ultimate cell borders, in some embodiments. The pull-back distance of the ACCs 240a-b from the cell edges should be sufficient to electrically isolate the ACCs 240a-b from the CCC/substrate 210. Formation of the anode current collectors 240a-b substantially completes formation of the active cells, except for routing the current at/on the anode current collectors 240a-b to a battery terminal.

An advantage of the present method is that some/all (e.g., all but one) of the active battery layers (e.g., the cathode 110, the low-impedance interface film 140, the solid-state electrolyte 220, and optionally, the lithiophilic layer 230) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 110 and the SSE 220 can be slightly pulled back from the cell edge by subtractive patterning (e.g., low-resolution photolithography, laser ablation) or selective deposition (as described herein).

Referring to FIG. 7, the substrate 300 is attached to a tape or sheet (not shown), and the lithiophilic layer 230, the electrolyte 220, the low-impedance interface film 140, the cathode 110 and the substrate 300 are cut or diced along the “ACC edges” of the battery cells to form an opening every other cell, or every other row or column of cells (when the cells are in an array or on a multi-column roll; see, e.g., U.S. Provisional Pat. Appl. Nos. 63/______,______ and 63/______,______ [Atty. Docket Nos. IDR2022-02-PR and IDR2022-02-PR], filed contemporaneously herewith, and the relevant portions of which are incorporated herein by reference). The tape or sheet is generally a UV release tape or sheet, containing an adhesive on one or both major surfaces that loses its adhesive properties upon sufficient irradiation with ultraviolet (UV) light. The tape or sheet may be on a ring or other frame, configured to mechanically support the tape or sheet and allow some tension therein. The cells are cut by laser (e.g., laser ablation), mechanical dicing or stamping, for example. When the cells are in an array or on a multi-column roll, they may also be cut or diced along the x-direction in FIG. 6 between adjacent cells (e.g., every column, or every row) to form isolated cell pairs. The sidewalls along the cuts fully expose the entire cell stack, including the CCC/substrate 210.

After the diced cell pairs are released from the tape or sheet 160, the cell pairs are encapsulated with a mechanically compliant moisture barrier and electrical insulation film 170. The barrier/insulation film 170 may comprise parylene, polyethylene, polypropylene, or another polyolefin, with or without a thin inorganic oxide or nitride overlayer such as Al₂O₃, SiO₂ or Si₃N₄ (e.g., a parylene/Al₂O₃ bilayer). Alternatively, the barrier/insulation film 170 may comprise a polycarbonate or a diamond-like (e.g., amorphous carbon) coating. The barrier/insulation film 170 covers all front, back and side surfaces of all cell pairs, and may be formed by pyrolysis, thermal CVD, ALD, inkjet printing, or screen printing.

Vias or openings are formed in the barrier/insulation film 170 to expose a part of the ACCs 240a-b and connect the ACCs 240a-b to a subsequently formed external battery terminal. The vias or openings may be formed in the barrier/insulation film 170 by (i) laser ablation or (ii) photolithographic masking and etching. Alternatively, the vias or openings may be formed by patterned encapsulation/deposition of the material(s) for the barrier/insulation film 170 on the upper surface of the cells, or by physical masking/unmasking using dispensable or preformed adhesives or magnets.

A redistribution metal layer 180 is formed on the ACC 240 (in the vias or openings), on the barrier/insulation film 170, and along the ACC edge of the diced cell. The redistribution layer 180 may comprise Cu, Ni, Al, or another suitable and/or stable (e.g., air- and/or water-stable) metal, and may be formed by sputtering, ALD or thermal evaporation (e.g., through a mask that exposes a region of the cell corresponding to the pattern of the redistribution layer 180, followed by removal of the mask, or by blanket deposition, followed by photolithographic patterning and etching), or by selective deposition, such as inkjet printing, aerosol-jet printing or screen printing. The redistribution layer (or ACC trace) 180 goes from the ACCs 240 exposed through the vias or openings to the ACC edge of the cell, in the opposite direction from the exposed edge(s) of the CCC/substrate 210 and cathode 110.

The ACC trace 180 electrically contacts the ACC 240 through the via, but is physically and electrically insulated from the CCC/substrate 210 by the barrier/insulation film 170. When the ACC trace 180 is a metal, it forms an intrinsic barrier to ambient ingress in the region of the via or opening. The ACC trace 180 is both physically on the top surface of the cell and covering at least part of one of the cell sidewalls. The ACC trace 180 on the cell sidewall enables electrical connection to the cell through a terminal on the side of the battery at a later stage of the method.

Prior to singulation (dicing), the cell pairs may be placed on an epoxy-coated tape. In this case, dicing along the CCC edges (i.e., to expose the CCC/substrate 210 and the cathode 110) creates the single cells. The epoxy coating 195 on the tape holds the cells together during stacking (not shown), and may provide a passivation/sealing layer on one side or surface of the cells during packaging. Thus, the coated tape may comprise a die attach film (DAF). Singulation may be conducted by laser dicing, but mechanical dicing and stamping are also possible. Thus, the epoxy coating 195 may also be cut during singulation.

As shown in FIG. 8, after removal of the cells from the tape, a dummy cell 210 (e.g., a metal foil substrate encapsulated as described above) may be placed on top of the singulated cell as a moisture and air barrier and to protect the cell from externally-caused damage. Battery terminal dipping and plating forms external electrical contacts 230a-b, thereby completing the battery 350. End terminals at the CCC and ACC edges (e.g., the exposed edges of the CCC 210 and the redistribution layer 180, respectively) are dipped into or coated with a conductive epoxy to form the CCC terminal 230a and ACC terminal 230b of the packaged battery 350. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating part or all of the CCC terminal 230a and ACC terminal 230b creates a solderable surface for PCB attachment by the end user. For solderable termination, the epoxy surface may be plated with Ni, Ag, In, Sn, or a combination thereof (e.g., Ni, then with In or Sn).

In some embodiments, the conductive epoxy 230a-b contains a relatively high metal content, which can retard ambient ingress (e.g., of oxygen or water vapor). The epoxy 230a-b may be plated with one or more pure metal layers, to further block ambient ingress. Both of these features help with ambient air resistance, particularly on the CCC edge, due to the barrier/insulation film 170 being diced at this edge during cell singulation from the cell pairs (FIG. 7).

Stacking the singulated cells forms a multi-layer set of parallel cells with the CCC (substrate) edges along one side of the stack, and the ACC edges (including the ACC trace/redistribution layers 180) along the opposite side. The epoxy adhesion 195b between cells can be from the coated tape or from a liquid die attach (DA) process, and can be applied to the back and/or front major surface of the cells, prior to or after cell singulation. If not applied as part of a DAF, the epoxy 195a-b can be applied by well-known methods such as b-stage laminated film formation, dispensing, jetting, inkjet printing, screen printing, etc. The stacked cells form a multi-cell solid-state battery after packaging. The parallel cells each additively contribute to the overall battery capacity.

Cell stacking may comprise a conventional pick-and-place technique. However, other stacking methods, such as strip folding, strip stacking, etc. (see, e.g., U.S. patent application Ser. No. 17/185,122, filed Feb. 25, 2021 [Attorney Docket No. IDR2020-02], the relevant portions of which are incorporated herein by reference), before or after dicing are also acceptable

### An Exemplary Solid-State Battery

FIG. 8 shows a cross-section of an exemplary solid-state battery 350. The battery 350 includes a plurality of cells, each comprising a cathode current collector 210, a cathode 110 (e.g., LCO) on the cathode current collector (CCC) 210, a low-impedance interface film 140 on the cathode 110, a solid-state electrolyte 220 on the low-impedance interface film 140, a lithiophilic layer 230 on the electrolyte 220, an anode current collector (ACC) 140 on the lithiophilic layer 230, a barrier/insulation film 170 with a via or opening therein exposing the ACC 140, and a conductive redistribution layer 180 on the ACC 140 (in the via or opening) and on the barrier/insulation film 170. The barrier/insulation film 170 encapsulates CCC/substrate 110 and any barrier thereon, the cathode 110, the low-impedance interface film 140, the electrolyte 220, the lithiophilic layer 230, and the ACC 140. The redistribution layer 180 is also on a first sidewall (the “ACC edge”) of the cell. A layer of epoxy or other adhesive 195a-b may be above or below the cell, or between adjacent cells in a stack of such cells, and a dummy cell 210 (e.g., an encapsulated or passivated metal/metal alloy foil) may be on the top or the underside of the stack. The battery 350 also includes first and second terminals on opposite sides or edges (e.g., the ACC and CCC edges) of the cell or stack, electrically connected to each ACC 140 (e.g., through the redistribution layer 185) on the first side and to each CCC 210 on the second, opposite side.

In some embodiments, a thin stainless-steel (SS) substrate 210 serves as the cathode current collector. In such embodiments, there is no need for a separate CCC layer, which consumes space in the battery 350 and increases complexity of the method of making the battery. SS is mechanically strong, and therefore, its thickness can be minimized (e.g., to 3-50 μm) to maximize cell energy density. The substrate 210 can be further encapsulated by a barrier metal 215a-b to suppress diffusion between the substrate 210 and the cathode 110 (as well as any overlying layer).

In some embodiments, the present battery 350 includes an anode-free ACC 140, which may be defined with minimal pull-back from the cell edges. This design also maximizes area utilization. Furthermore, the use of underlying blanket cathodes 110 and solid-state electrolytes 220 result in a flat or planar ACC over the other battery layers, which minimizes mechanical stresses from Li plating and/or stripping during cell cycling.

The present solid-state battery and method protect the cell(s) from ambient ingress by encapsulation of top/bottom/sides of the cell(s) with an ambient-resistant barrier, and capping the sides with a conductive epoxy and plated metal(s) to form externally-facing electrical terminals and further retard ambient ingress. A via and redistribution layer 180 connect the ACC 140 to one of the external electrical terminals. The present solid-state battery and method have the following advantages and differentiation(s):
The low-impedance interface film 140 and the lithiophilic layer 230 on opposite surfaces of the electrolyte 220 reduce impedance in the battery and enhance formation and stability of any lithium anode that forms during charging.
No ceramic substrate, which removes the need for an additional CCC layer.
In some embodiments, no requirement for patterned active battery layers, which improves total active area (charge capacity) and area efficiency, decreases process complexity, and eliminates potentially challenging topographies.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A solid-state battery cell, comprising:
a cathode current collector;
a cathode on the cathode current collector;
a low-impedance interface film on the cathode;
a solid-state electrolyte on or over the low-impedance interface film;
a lithiophilic layer on or over the solid-state electrolyte; and
an anode current collector on or over the lithiophilic layer.

2. The solid-state battery cell of claim 1, wherein the low-impedance interface film comprises (i) an oxide, a nitride or an oxynitride of lithium and a metal selected from aluminum, silicon and titanium, (ii) carbon, (iii) an oxide of a Group 14, 15 or 16 metal, (iv) a fluoride, oxyfluoride or phosphate of a Group 13, 14 or 15 metal, or (v) an alkali metal borate.

3. The solid-state battery cell of claim 2, wherein the cathode comprises a lithium metal oxide or a lithium metal phosphate.

4. The solid-state battery cell of claim 2, wherein the low-impedance interface has a thickness of 5-100 Å.

5. The solid-state battery cell of claim 1, wherein the solid-state electrolyte layer comprises lithium phosphorus oxynitride.

6. The solid-state battery cell of claim 5, wherein the lithiophilic layer comprises a metal oxide, a metal silicate, a metal aluminate, a metal aluminosilicate, a metal fluoride, or an elemental main group metal or metalloid.

7. The solid-state battery cell of claim 1, wherein the anode current collector comprises nickel, tungsten, copper, titanium or an alloy or conductive nitride thereof.

8. The solid-state battery cell of claim 7, wherein the anode current collector has a thickness of 1000-10,000 Å.

9. The solid-state battery cell of claim 1, wherein the cathode current collector comprises a metal foil.

10. The solid-state battery cell of claim 9, wherein the metal foil comprises stainless steel, aluminum, copper, nickel, inconel, brass, molybdenum or titanium, and the aluminum, copper, nickel, molybdenum or titanium may be alloyed with up to 10% of one or more other elements.

11. The solid-state battery cell of claim 10, further comprising first and second barriers on opposite surfaces of the cathode current collector, wherein each of the first and second barriers comprises one or more layers of one or more metal nitrides in a thickness effective to prevent migration of atoms or ions from the metal foil.

12. A solid-state battery, comprising:
the solid-state battery cell of claim 1;
barrier and/or insulation film encapsulating the substrate, the cathode, the multi-layer solid-state electrolyte and the anode current collector;
an opening in the barrier and/or insulation film exposing the anode current collector; and
a conductive redistribution layer on the exposed anode current collector, the barrier and/or insulation film, and a first sidewall of the solid-state battery cell.

13. The solid-state battery of claim 12, further comprising first and second terminals, one electrically connected to the anode current collector, and the other electrically connected to the cathode or the cathode current collector.

14. A method of making a solid-state battery cell, comprising:
forming a cathode on a substrate,
forming a low-impedance interface film on the cathode,
forming a solid-state electrolyte on or over the low-impedance interface film,
forming a lithiophilic layer on or over the solid-state electrolyte, and
forming an anode current collector on or over the lithiophilic layer.

15. The method of claim 14, wherein forming the low-impedance interface film comprises depositing or growing by atomic layer deposition (i) an oxide, a nitride or an oxynitride of lithium and a metal selected from aluminum, silicon and titanium, (ii) carbon, (iii) an oxide of a Group 14, 15 or 16 metal, (iv) a fluoride, oxyfluoride or phosphate of a Group 13, 14 or 15 metal, or (v) an alkali metal borate.

16. The method of claim 15, wherein forming the solid-state electrolyte comprises depositing or growing the solid-state electrolyte by atomic layer deposition using a same process tool as for depositing or growing the low-impedance interface film, without exposing the low-impedance interface film and the electrolyte layer to air.

17. The method of claim 16, wherein forming the lithiophilic layer comprises depositing the lithiophilic layer by atomic layer deposition using the same process tool.

18. The method of claim 16, wherein forming the anode current collector comprises depositing the anode current collector by physical vapor deposition.

19. The method of claim 14, further comprising:
encapsulating the substrate, the cathode, the low-impedance interface film, the solid-state electrolyte, the lithiophilic layer and the anode current collector,
forming an opening in the encapsulation exposing the anode current collector, and
forming a conductive redistribution layer on the exposed anode current collector and the encapsulation, the redistribution layer also being on a first sidewall of the solid-state battery cell.

20. A method of making a solid-state battery, comprising:
the method of claim 19,
placing an adhesive on the solid-state battery cell, and
depositing a conductor on each of the first sidewall and a second, opposite sidewall of the solid-state battery cell to form first and second terminals of the solid-state battery.
